(19) United States
(12) Patent Application Publication
(10) Pub. No.: US 2016/0004114 A1
(43) Pub. Date: Jan. 7, 2016

(54) LIQUID CRYSTAL DISPLAY DEVICE

(71) Applicant: Japan Display Inc., Tokyo (JP)

(72) Inventor: Yuki KURAMOTO, Tokyo (JP)

(21) Appl. No.: 14/789,384

(22) Filed: Jul. 1, 2015

(30) Foreign Application Priority Data
Jul. 2, 2014 (JP) 2014-136797

(51) Int. Cl. G02F 1/1339; G02F 1/1343; G02F 1/1333; G02F 1/1368; G02F 1/1337

(52) U.S. Cl. CPC G02F 1/13394; G02F 1/1368; G02F 1/1337; G02F 1/133345; G02F 1/134309; G02F 2001/13396

(57) ABSTRACT

The displacement between a TFT substrate and a counter substrate is prevented when an external pressing pressure is applied to a liquid crystal display device, and an alignment film is prevent from being shaved by a columnar spacer. A liquid crystal display device includes a first substrate having a recess and an upper part other than the recess, a second substrate having a first columnar spacer and a second columnar spacer, and a liquid crystal sandwiched between the substrates. The first columnar spacer contacts the upper part of the first substrate; the second columnar spacer is inserted into the recess of the first substrate, and a gap exists between a tip end portion of the second columnar spacer and a bottom part of the recess; and a height of the second columnar spacer is higher than a height of the first columnar spacer.

### CLAIM OF PRIORITY

The present application claims priority from Japanese Patent Application JP 2014-136797 filed on Jul. 2, 2014, the content of which is hereby incorporated by reference into this application.

### BACKGROUND OF THE INVENTION

(1) Field of the Invention

The present disclosure relates to a liquid crystal display device, and more specifically to a liquid crystal display device that takes measures against displacement in the direction of the main surfaces between substrates and takes measures against a shave on an alignment film caused by a spacer.

(2) Description of the Related Art

In the liquid crystal display device, a TFT substrate is formed with a pixel electrode, a thin film transistor (a TFT), and the like in a matrix configuration, a counter substrate is disposed opposite to the TFT substrate, and a liquid crystal is sandwiched between the TFT substrate and the counter substrate. An image is formed by controlling the optical transmittance of liquid crystal molecules for individual pixels. On the TFT substrate and the counter substrate, an alignment film that initially orients a liquid crystal is formed on the surface contacting the liquid crystal.

In order to define a distance between the TFT substrate and the counter substrate (in the following, also referred to as a gap), a method is used in which a columnar spacer is formed on the counter substrate. On the other hand, after a liquid crystal display device is completed, when an external pressure is applied to the counter substrate in the operation, the gap is varied to cause a display failure. In order to prevent this failure, such a method is developed in which in addition to a first columnar spacer that defines the gap between the TFT substrate and the counter substrate in the normal state, a second columnar spacer is formed to contact the TFT substrate in the case where a pressure is applied to the counter substrate and the like, and this second columnar spacer counters a pressing pressure.

On the other hand, in the case where a pressing pressure is applied to the counter substrate, such a phenomenon is taken place in which the TFT substrate and the counter substrate are displaced to each other in the direction of the main surfaces of the substrates (in the following, also simply referred to as the displacement between the TFT substrate and the counter substrate), and this is a cause of color mixture. For a scheme that prevents the color mixture, Japanese Unexamined Patent Application Publication No. 2013-186148 describes a technique in which a first columnar spacer that contacts a TFT substrate is formed, a recess is formed on the TFT substrate, and a second columnar spacer is formed to contact the bottom part of the recess. In other words, since the motion of the second columnar spacer contacting the recess is constrained by the recess, a counter substrate is difficult to move in the direction of the main surface with respect to the TFT substrate.

### SUMMARY OF THE INVENTION

The technique described in Japanese Unexamined Patent Application Publication No. 2011-22535 is the technique in which the displacement between the counter substrate and the TFT substrate in the direction of the main surfaces is prevented using the second columnar spacer formed on the counter substrate and inserted into the recess on the TFT substrate. In other words, in the technique described in Japanese Unexamined Patent Application Publication No. 2013-186148, the second columnar spacer is formed on the counter substrate side corresponding to the recess on the TFT substrate side. However, this second columnar spacer also contacts the bottom part of the recess in the normal state.

The alignment film is formed on the surface of the TFT substrate contacting the liquid crystal. At the beginning, for the alignment film, a liquid alignment film material is applied by flexographic printing, ink jet printing, or the like. In this application, on the recess formed on the TFT substrate, the alignment film material is prone to be formed thicker than on the other portions. When the columnar spacer contacts this portion, such a phenomenon is caused in which the columnar spacer shaves the alignment film. When the shavings of the alignment film are dispersed in the liquid crystal, light leakage is taken place at this portion.

It is an object of the present disclosure to prevent the displacement between a TFT substrate and a counter substrate in the direction of the main surfaces of the substrates and to prevent an alignment film being shaved by a columnar spacer in the case where an external pressure is applied to the counter substrate and the like in a liquid crystal display device.

The present disclosure is to overcome the problems, and includes main schemes as follows.

(1) A liquid crystal display device including: a first substrate having a recess and an upper part other than the recess; a second substrate having a first columnar spacer and a second columnar spacer; and a liquid crystal sandwiched between the first substrate and the second substrate. In the liquid crystal display device, the first columnar spacer contacts the upper part of the first substrate; the second columnar spacer is inserted into the recess of the first substrate, and a gap exists between a tip end portion of the second columnar spacer and a bottom part of the recess; and a height of the second columnar spacer is higher than a height of the first columnar spacer.

(2) In the liquid crystal display device according to (1), the recess is formed of a half hole formed on an organic film formed on the first substrate.

(3) In the liquid crystal display device according to (1), the recess is formed of a through hole formed on an organic film formed on the first substrate.

(4) In the liquid crystal display device according to (1), the recess is formed of a first recess in a center part and a second recess surrounding the first recess; the first recess is formed of a portion that an organic film formed on the first substrate is decreased in thickness by half-etching, and the second recess is formed of a region that the organic film formed on the first substrate is removed; a gap exists between a tip end of the second columnar spacer and bottom parts of the first recess and the second recess; and a distance between the tip end of the second columnar spacer and the bottom part of the first recess is smaller than a distance between the tip end of the second columnar spacer and the bottom part of the second recess.

(5) In the liquid crystal display device according to (1), ITO is formed on an inner surface of the recess.

(6) In the liquid crystal display device according to (1), ITO having a first width is formed on the upper part surrounding an outer end portion of the recess.

(7) In the liquid crystal display device according to any one of (1) to (6), a number of the second columnar spacers is greater than a number of the first columnar spacers.

### BRIEF DESCRIPTION OF THE DRAWINGS

FIG. 1 is a cross sectional view of a liquid crystal display device in an IPS mode;

FIG. 2 is a plan view of an embodiment of the present disclosure;

FIG. 3 is a cross sectional view of an embodiment of the present disclosure;

FIG. 4 is a detailed cross sectional view of a recess on a TFT substrate;

FIG. 5 is a detailed cross sectional view of a first embodiment;

FIG. 6 is a cross sectional view of a second embodiment;

FIG. 7 is a cross sectional view of a third embodiment;

FIG. 8 is a cross sectional view of a fourth embodiment;

FIG. 9 is a cross sectional view of a fifth embodiment; and

FIG. 10 is a plan view of the fifth embodiment.

### DETAILED DESCRIPTION OF THE PREFERRED EMBODIMENTS

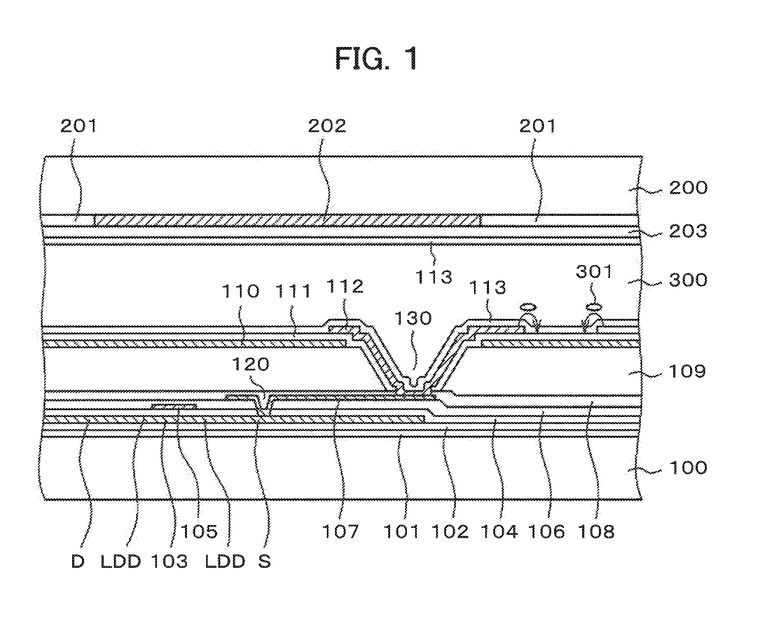

Prior to describing embodiments of the present disclosure, the structure of a liquid crystal display device in the IPS mode will be described. However, the present disclosure is applicable to liquid crystal display devices in other modes such as the TN mode and the VA mode as well as the IPS mode. FIG. 1 is a cross sectional view of the pixel portion of a liquid crystal display device to which the present disclosure is applied in the IPS mode. A TFT in FIG. 1 is a so-called top gate TFT, and for a semiconductor to be used, an LTPS (Low Temperature Poli-Si) semiconductor is used. On the other hand, in the case where an a-Si semiconductor is used, a so-called bottom gate TFT is often used. In the following description, a description will be made as the case of using a top gate TFT is taken as an example. However, the present disclosure is also applicable to the case of using a bottom gate TFT.

In FIG. 1, a first base film 101 formed of SiN and a second base film 102 formed of SiO₂ are formed on a glass substrate 100 by CVD (Chemical Vapor Deposition). The roles of the first base film 101 and the second base film 102 are to prevent impurities produced from the glass substrate 100 from contaminating a semiconductor layer 103.

The semiconductor layer 103 is formed on the second base film 102. This semiconductor layer 103 is a layer that an a-Si film is formed on the second base film 102 by CVD and the a-Si film is subjected to laser annealing and converted into a poly-Si film. The poly-Si film is patterned by photolithography.

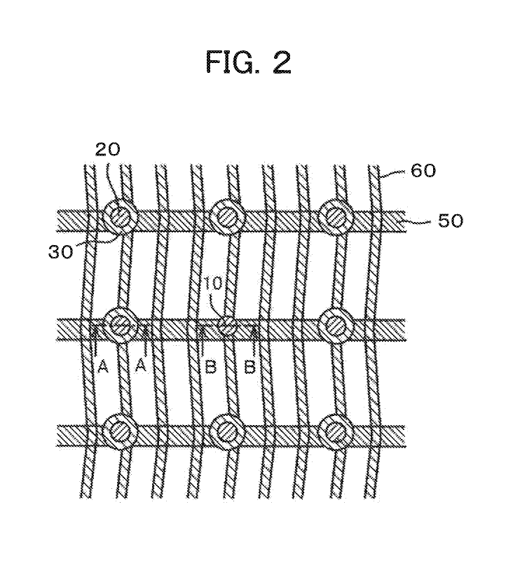

A gate insulating film 104 is formed on the semiconductor layer 103. This gate insulating film 104 is an SiO₂ film formed of TEOS (tetraethoxysilane). This film is also formed by CVD. A gate electrode 105 is formed on the gate insulating film 104. A scanning line 50 illustrated in FIG. 2 also serves as the gate electrode 105. The gate electrode 105 is formed of a MoW film, for example. When it is necessary to decrease the resistance of the gate electrode 105 or the scanning line 50, an Al alloy is used.

The gate electrode 105 is patterned by photolithography. In this patterning, an impurity such as phosphorus and boron is doped to the poly-Si layer by ion implantation, and a source S or a drain D is formed on the poly-Si layer. Moreover, using the photoresist of the gate electrode 105 in patterning, a LDD (Lightly Doped Drain) layer is formed between a channel layer and the source S or the drain D on the poly-Si layer.

After the formation, a first interlayer insulating film 106 is formed using SiO₂ to cover the gate electrode 105. The first interlayer insulating film 106 is formed to insulate the gate electrode 105 from a contact electrode 107. On the first interlayer insulating film 106 and the gate insulating film 104, a contact hole 120 is formed that connects a source portion S of the semiconductor layer 103 to the contact electrode 107. Photolithography for forming the contact hole 120 on the first interlayer insulating film 106 and the gate insulating film 104 is performed simultaneously.

The contact electrode 107 is formed on the first interlayer insulating film 106. The contact electrode 107 is connected to a pixel electrode 112 through a contact hole 130. The drain D of the TFT is connected to a picture signal line 60 illustrated in FIG. 2 through the through hole at a portion not illustrated.

The contact electrode 107 and the picture signal line are simultaneously formed on the same layer. The contact electrode 107 and the picture signal line (in the following, represented by the contact electrode 107) use an AlSi alloy, for example, for decreasing resistance. Since the AlSi alloy causes a hillock, or Al spreads to the other layers, such a structure is provided in which AlSi is sandwiched using a MoW barrier layer and a cap layer, for example, not illustrated.

An inorganic passivation film (an insulating film) 108 is applied to cover the contact electrode 107 for protecting the entire TFT. The inorganic passivation film 108 is formed by CVD similarly to the first base film 101. An organic passivation film 109 is formed to cover the inorganic passivation film 108. The organic passivation film 109 is formed of a photosensitive acrylic resin. The organic passivation film 109 can be formed of a silicone resin, epoxy resin, polyimide resin, and the like in addition to an acrylic resin. Since the organic passivation film 109 serves as a planarization film, the organic passivation film 109 is formed thick. Although the film thickness of the organic passivation film 109 ranges from 1 to 4 μm, and in many cases, the film thickness ranges from about 2 to 3 μm.

In order to provide conduction between the pixel electrode 120 and the contact electrode 107, the contact hole 130 is formed on the inorganic passivation film 108 and the organic passivation film 109. For the organic passivation film 109, a photosensitive resin is used. After the application of a photosensitive resin, when this resin is exposed, only portions to which light is applied are dissolved in a certain developer. In other words, with the use of a photosensitive resin, the formation of a photoresist can be omitted. After the contact hole 130 is formed on the organic passivation film 109, the organic passivation film is burned at a temperature of about 230° C., and the organic passivation film 109 is completed.

After the completion, ITO (Indium Tin Oxide) to be a common electrode 110 is formed by sputtering, and patterned so as to remove ITO from the contact hole 130 and the peripheral portion of the contact hole 130. The common electrode 110 can be formed in a flat surface in common in the pixels. After the formation, SiN to be a second interlayer insulating film 111 is formed throughout the surface by CVD. After the formation, in the contact hole 130, a contact hole that provides conduction between the contact electrode 107 and the pixel electrode 112 is formed on the second interlayer insulating film 111 and the inorganic passivation film 108.

After the formation, ITO is formed by sputtering and patterned, and the pixel electrode 112 is formed. An alignment film material is applied on the pixel electrode 112 by flexographic printing, ink jet printing, or the like and burned, and an alignment film 113 is formed. For the alignment process of the alignment film 113, photo-alignment with polarized ultraviolet rays is used as well as a rubbing method.

When a voltage is applied across the pixel electrode 112 and the common electrode 110, an electric line of force is produced as illustrated in FIG. 1. This electric field rotates liquid crystal molecules 301, the light quantity passed through a liquid crystal layer 300 is controlled for the individual pixels, and an image is formed.

In FIG. 1, a counter substrate 200 is disposed as the liquid crystal layer 300 is sandwiched. A color filter 201 is formed on the inner side of the counter substrate 200. The color filter 201 is formed with a red color filter 201R, a green color filter 201G, and a blue color filter 201B for the individual pixels, and a color image is formed using the filters. A black matrix 202 is formed between the color filter 201 and the color filter 201 to improve the contrast of the image. It is noted that the black matrix 202 also serves as the light shielding film of the TFT, and prevents a photocurrent from being carried through the TFT.

An overcoat film 203 is formed to cover the color filter 201 and the black matrix 202. Since the surfaces of the color filter 201 and the black matrix 202 have irregularities, the surfaces are flattened with the overcoat film 203. On the overcoat film, an alignment film 113 is formed to determine the initial orientation of the liquid crystal. Similarly to the alignment film 113 on the TFT substrate 100 side, a rubbing method or a photo-alignment method is used for the alignment process of the alignment film 113.

The gap between the TFT substrate 100 and the counter substrate 200, that is, the layer thickness of the liquid crystal layer 300 is defined by a columnar spacer illustrated in FIG. 2 and diagrams later. In the following, the present disclosure will be described in detail with reference to embodiments.

### First Embodiment

FIG. 2 is a plan view of the TFT substrate 100 according to the present disclosure. In FIG. 2, the scanning lines 50 are extended in the lateral direction, and arrayed in the vertical direction at a predetermined pitch, and the picture signal lines 60 are extended in the vertical direction, and arrayed in the lateral direction at a predetermined pitch. In FIG. 2, the picture signal line 60 is slightly tilted to the vertical direction. This is because in the liquid crystal display device in the IPS mode, the long axis direction of the pixel electrode is tilted to the left and the right for the individual pixels adjacent in the vertical direction, and the viewing angle characteristics are uniformized. In this case, the alignment direction of the alignment film for a liquid crystal is set in the vertical direction, and the orientation direction of the liquid crystal molecules is slightly tilted to the pixel electrode. This is because the purpose is the prevention of the occurrence of a so-called domain.

In FIG. 2, a first columnar spacer 10 and a second columnar spacer 20 formed on the counter substrate are disposed on the intersection points of the scanning lines 50 with the picture signal lines 60. In FIG. 2, a circle on the outer side of the columnar spacer is a recess 30 formed on the TFT substrate. In the present disclosure, since the second columnar spacer 20 is inserted into the inner side of the recess 30, the displacement of the counter substrate 200 to the TFT substrate 100 is restricted by the recess 30, and the positional displacement between the TFT substrate 100 and the counter substrate 200 is small even in the case where a pressing pressure is externally applied to the counter substrate 200.

Since the orientation of the liquid crystal is disturbed on the peripheral portion of the columnar spacer, the light shielding film is formed corresponding to the columnar spacer. In a previously existing example in which a recess corresponding to the columnar spacer is not provided, since the first columnar spacer 10 is greatly displaced, the diameter of the light shielding film 202 on the portion corresponding to the first columnar spacer 10 was formed greater than the diameter of the light shielding film 202 on the portion corresponding to the second columnar spacer. In contrast to this, in the present disclosure, the displacement between the TFT substrate 100 and the counter substrate 200 is small, so that a diameter φb1 of the region of the light shielding film 202 corresponding to the first columnar spacer 10 can be made equal to a diameter φb2 of the region of the light shielding film 202 corresponding to the second columnar spacer 20. In the present disclosure, the transmittance of the pixel can be increased, accordingly.

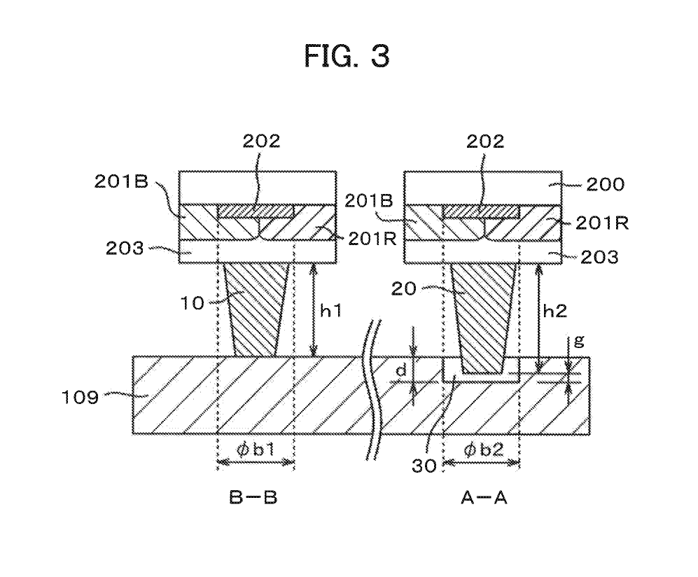

FIG. 3 is a cross sectional view corresponding to a cross section along line A-A and a cross section along line B-B in FIG. 2. In FIG. 3, the first columnar spacer 10 contacts the TFT substrate 100 side in the normal state. Although the second columnar spacer 20 is inserted into the recess 30 formed on the organic passivation film 109 of the TFT substrate 100, the tip end of the second columnar spacer 20 does not contact the bottom part of the recess 30. The depth of the recess 30 ranges from 1.3 to 1.5 μm, for example.

The height of the second columnar spacer 20 is higher than the height of the first columnar spacer 10 by about 1 μm, for example. On the other hand, since the depth of the recess 30 ranges from 1.3 to 1.5 μm, a gap of about 0.3 to 0.5 μm exists between the tip end of the second columnar spacer 20 and the bottom face of the recess 30. In other words, the tip end of the second columnar spacer 20 does not contact the TFT substrate 100 side in the normal state, and in the case where an external force is applied to the counter substrate 200, the tip end contacts the bottom part of the recess 30 to prevent the gap from decreasing.

Therefore, the opportunity of the second columnar spacer 20 to shave the alignment film 113 is small, and even though the second columnar spacer 20 contacts the bottom part of the recess 30, such an event can be prevented that the second columnar spacer 20 is greatly deformed and the tip end strongly contacts the bottom part of the recess 30. Moreover, as illustrated in FIG. 2, the number of the first columnar spacers 10 is smaller than the number of the second columnar spacers 20. Therefore, in the present disclosure, since the number of the first columnar spacers 10 that highly possibly shave the alignment film 113 is small, the amount of the alignment film to be shaved is small in the present disclosure also from this viewpoint.

Furthermore, in the present disclosure, since the second columnar spacer 20 is inserted into the recess 30 on the TFT substrate 100, when the TFT substrate 100 and the counter substrate 200 are greatly displaced, the second columnar spacer 20 contacts the side wall of the recess 30 to suppress the displacement between the substrates. Therefore, even though the first columnar spacer 10 is deformed, light leakage caused by the deformation can be made smaller than in the previously existing one because the displacement between the TFT substrate 100 and the counter substrate 200 is small, so that the area of the black matrix 202 that takes measures against light leakage can be made smaller, and the transmittance of the liquid crystal display panel can be improved. In addition, since the number of the second columnar spacers 20 is greater than the number of the first columnar spacers 10, the amount of displacement in the direction of the main surfaces of the counter substrate 200 and the TFT substrate 100 can be made smaller also from this viewpoint.

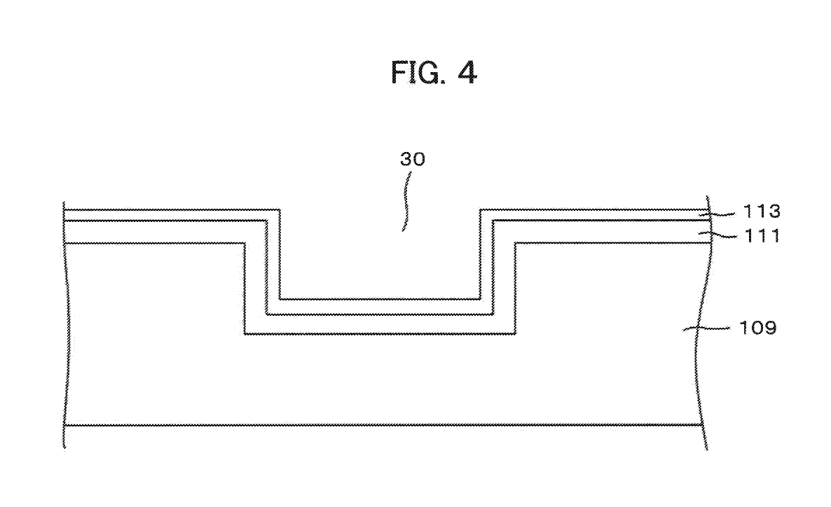

FIG. 4 is a detailed cross sectional view of the recess 30 formed on the TFT substrate 100. In FIG. 4, a half hole is formed on the organic passivation film 109 using a half-exposure method. The second interlayer insulating film 111 (in the following, simply referred to as the interlayer insulating film 111) is formed on the organic passivation film 109, and the alignment film 113 is formed on the interlayer insulating film 111. In FIG. 3, the second columnar spacer 20 is inserted into the recess 30 formed on the organic passivation film 109. Actually, the second columnar spacer 20 faces the alignment film 113 or the interlayer insulating film 111. This is similar in the drawings below.

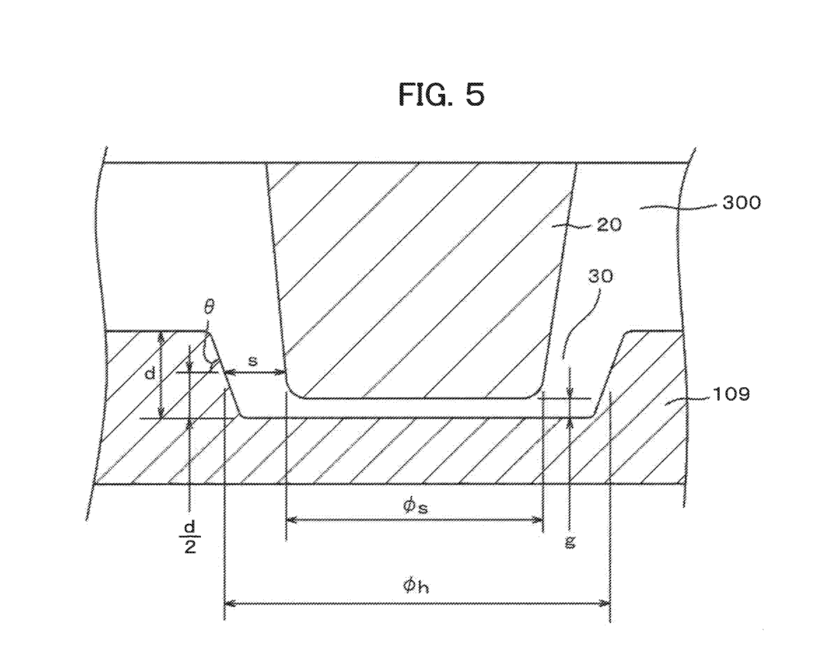

FIG. 5 is a cross sectional view of the dimensional relationship between the second columnar spacer 20 and the recess 30. In FIG. 5, the second columnar spacer 20 directly faces the organic passivation film 109. However, in the actual liquid crystal display device, the second columnar spacer 20 faces the interlayer insulating film 111, the alignment film 113, or the like as described in FIG. 4. Therefore, the actual dimensions are the dimensions on the interlayer insulating film 111 or the alignment film 113, or the distance between the second columnar spacer 20 and the interlayer insulating film 111 or the alignment film 113.

In FIG. 5, a depth d of the recess 30 ranges from 1.3 to 1.5 μm. A slope θ of the wall portion of the recess 30 at the position in a depth d/2 of the recess 30 in the depth direction ranges from angles of 60 to 90 degrees. When this angle is small, in the case where the counter substrate 200 is displaced in the direction of the main surface of the TFT substrate 100, the second columnar spacer 20 goes out of the recess 30, and the effect of the recess 30 as a stopper against displacement in the direction of the main surfaces becomes small.

In FIG. 5, a gap g between the tip end of the second columnar spacer 20 and the bottom part of the recess 30 ranges from 0.3 to 0.5 μm, for example. In other words, in the normal state, the second columnar spacer 20 does not contact the bottom part of the recess 30. Therefore, in the normal state, the alignment film 113 in the recess 30 is not peeled by the second columnar spacer 20. When the counter substrate 200 is pressed by an external force, the second columnar spacer 20 contacts the recess 30 to maintain the distance between the TFT substrate 100 and the counter substrate 200.

In FIG. 5, at the position in the depth d/2 of the recess 30 in the depth direction, a distance s between the walls of the second columnar spacer 20 and the recess 30 ranges from 2 to 5 μm. Therefore, even though the counter substrate 200 is to be displaced in the direction of the main surface of the TFT substrate 100, the counter substrate 200 is not displaced over the distance s. A diameter φs of the second columnar spacer 20 at the position in the depth d/2 of the recess 30 in the depth direction is 10 μm, for example. Moreover, a diameter φh of the recess 30 at the same position ranges from 14 to 20 μm. When the difference between φh and φs is small, the displacement between the TFT substrate 100 and the counter substrate 200 can be suppressed to a small displacement. However, when the displacement between the TFT substrate 100 and the counter substrate 200 is taken place from the beginning because of manufacture variations, it is likely that the second columnar spacer 20 is not entered into the recess 30. On the contrary, when the difference between φh and φs is great, the restriction to the displacement between the TFT substrate 100 and the counter substrate 200 in the direction of the main surfaces becomes weak.

### Second Embodiment

The first embodiment is an example in which the half hole is formed on the organic passivation film 109 in order to form the recess 30 on the TFT substrate 100. In this embodiment, a perfect hole (a through hole) is formed on the organic passivation film 109 in order to form a recess 30 on the TFT substrate 100. In other words, the embodiment is an example in which the through hole is formed on the organic passivation film 109 to further deepen the recess 30.

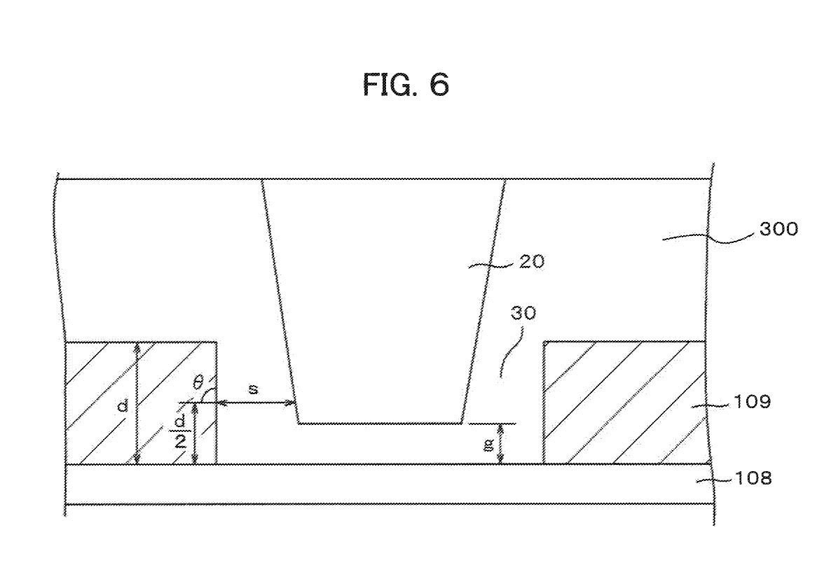

FIG. 6 is a cross sectional view of the embodiment. In FIG. 6, a through hole is formed on the organic passivation film 109. The second columnar spacer 20 faces the inorganic passivation film 108 formed under the organic passivation film 109. Also in FIG. 6, the interlayer insulating film 111 and the alignment film 113 are formed on the recess 30 similarly to the disruption in FIG. 4.

In FIG. 6, the gap g between the second columnar spacer 20 and the bottom part of the recess 30 facing the second columnar spacer 20 ranges from 0.3 to 0.5 μm. Therefore, the height of the second columnar spacer 20 is further increased as compared with the case of the first embodiment. The depth d of the recess 30 is the same as the film thickness of the organic passivation film 109, ranging from 2 to 3 μm. The distance s between the walls of the columnar spacer 20 and the recess 30 at the position of the depth d/2 of the recess 30 in the depth direction ranges from 2 to 5 μm similarly to the case of the first embodiment.

Although an angle θ of the wall of the recess 30 in FIG. 6 is an angle of 90 degrees, it is fine that this angle ranges from angles of 60 to 90 degrees similarly to the first embodiment. In the embodiment, the depth of the recess 30 is deep as compared with the case of the first embodiment, so that it is possible to decrease the probability that the second columnar spacer 20 goes out of the recess 30 in the case where the counter substrate 200 is displaced to the TFT substrate 100.

Moreover, in the embodiment, the recess 30 is formed simultaneously when the contact hole 130 is formed on the organic passivation film 109, which connects the contact electrode 107 to the pixel electrode 112 formed on the TFT substrate 100. However, the recess 30 also has the characteristics that the contact hole 130 and the recess 30 can be formed by lithography under the similar conditions. Similarly to the first embodiment, also in the embodiment, it is possible to suppress that the second columnar spacer 20 shaves the alignment film 113, and it is possible to suppress the displacement between the TFT substrate 100 and the counter substrate 200 in the direction of the main surfaces in a small amount.

### Third Embodiment

In the case where the second columnar spacer 20 is inserted into the recess 30, it is likely that the alignment film 113 remains thick on the recess 30. Even though such a design is provided in which a half hole is formed on the organic passivation film 109 and the second columnar spacer 20 does not contact the bottom part of the recess 30 in the normal state, it is likely that the alignment film 113 remains thick on the recess 30 and the alignment film 113 contacts the second columnar spacer 20 even in the normal state. Moreover, even though the second columnar spacer 20 does not contact the bottom part of the recess 30 in the normal state, when a pressing pressure is applied to the counter substrate 200 to cause the second columnar spacer 20 to contact the bottom part of the recess 30, a thick alignment film 113 increases the probability that the alignment film is peeled.

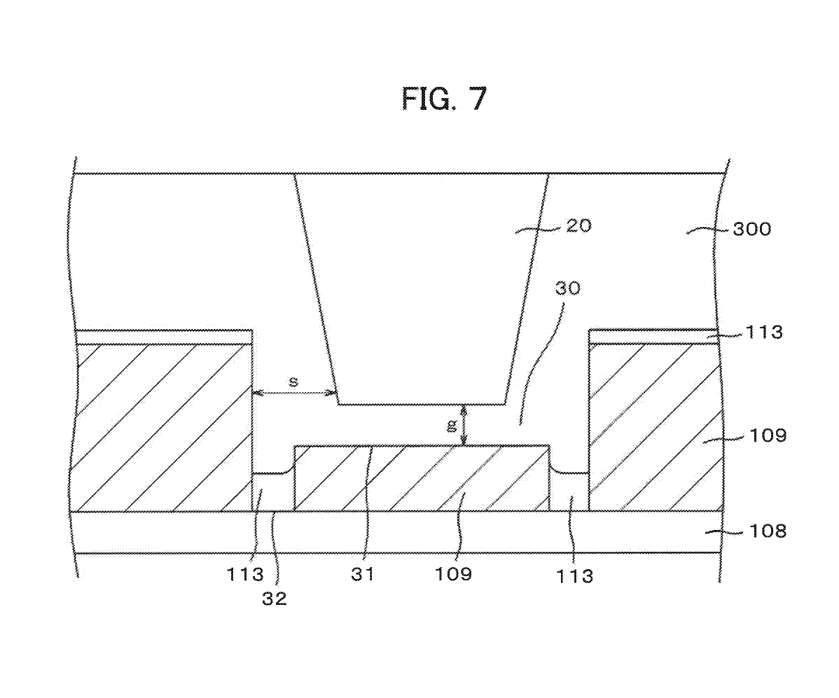

This embodiment provides a configuration effective to the case where this problem arises. FIG. 7 is a cross sectional view of a configuration according to the embodiment. In FIG. 7, the second columnar spacer 20 is inserted into a recess 30. The recess 30 is formed on the organic passivation film 109. The feature in FIG. 7 is in that the recess 30 includes a half-exposed first bottom part 31 and a second bottom part 32 that is a through hole around the first bottom part 31. In other words, the organic passivation film 109 exists on the first bottom part 31, the organic passivation film 109 does not exist on the second bottom part 32 around the first bottom part 31, and the inorganic passivation film 108 forms the second bottom part 32.

In the case where a pressing pressure is externally applied to the counter substrate 200, the tip end of the second columnar spacer 20 contacts the first bottom part 31. The gap g between the tip end of the second columnar spacer 20 and the second bottom part 32 and the distance s between the wall surfaces of the second columnar spacer 20 and the recess 30 are similar to FIG. 5.

In the embodiment, since the second bottom part 32 exists on the recess 30, when the alignment film 113 is applied, the leveling effect causes the alignment film 113 in the recess 30 to flow to the second bottom part 32, and only an alignment film in a thin film thickness is formed on the first bottom part 31. This state is illustrated in FIG. 7. As illustrated in FIG. 7, although the alignment film 113 in the recess 30 is formed thick on the second bottom part 32, the alignment film 113 is not formed on the first bottom part 31.

Therefore, even though the counter substrate 200 is distorted by external pressing force and the second columnar spacer 20 contacts the first bottom part 31 of the recess 30, the alignment film 113 does not exist on the first bottom part 31 or the alignment film 113 is formed thinly if exists, so that the probability that the alignment film 113 is shaved by the second columnar spacer 20 is very small. Therefore, in the embodiment, the probability of producing a bright spot caused by the shavings of the alignment film 113 is further smaller.

The recess 30 according to the embodiment is formed by processing performed simultaneously in the formation of the contact hole on the organic passivation film 109 to connect the pixel electrode 112 to the contact electrode 107. In other words, on the portion corresponding to the recess 30 on the organic passivation film 109, the first bottom part 31 can be formed by half-exposure to the corresponding portion, and the second bottom part 32 can be formed by full-exposure to the corresponding portion.

### Fourth Embodiment

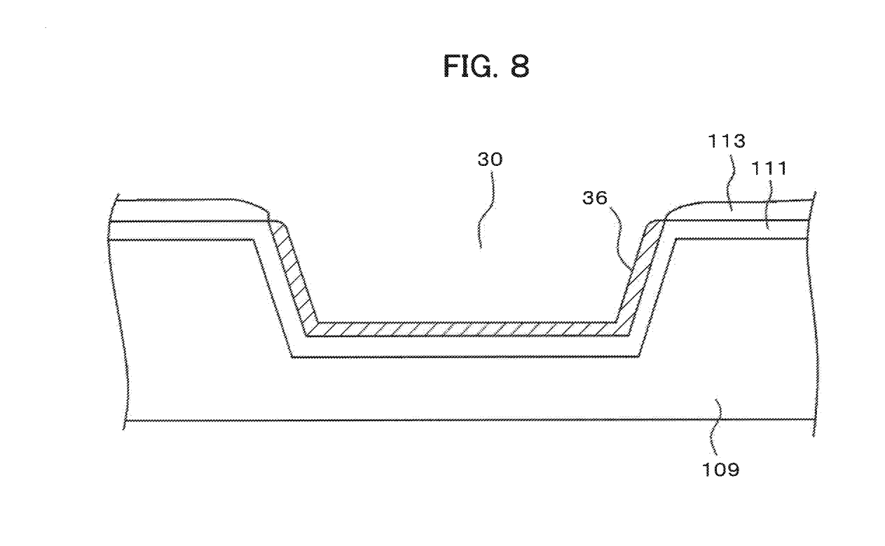

This embodiment provides a configuration in which the alignment film 113 is not flowed into the recess 30 on the TFT substrate 100. FIG. 8 is a cross sectional view of a recess 30 according to the embodiment. In FIG. 8, the recess 30 is formed on the organic passivation film 109 by half-exposure. The interlayer insulating film 111 formed of SiN and the like is formed to cover the organic passivation film 109. An ITO film 36 is formed on the surface of the recess 30 in which the top layer is the interlayer insulating film 111. On the other hand, the ITO film is not formed on the outer side of the recess 30.

Although a liquid alignment film material has an excellent wettability with SiN forming the interlayer insulating film 111, the liquid alignment film material has a poor wettability with the ITO film 36. Therefore, as illustrated in FIG. 8, an alignment film material is applied to the interlayer insulating film 111 on the outer side of the recess 30, but the alignment film material is not applied to the recess 30 on which the ITO film 36 is formed. Thus, even though an external pressure is applied to the counter substrate 200 to cause the second columnar spacer 20 to contact the recess 30, the alignment film 113 does not exist, and the shavings of the alignment film are not produced. Therefore, the occurrence of a bright spot caused by the shavings of the alignment film 113 can be prevented.

The ITO film 36 according to the embodiment can be formed simultaneously when the pixel electrode formed of ITO is formed. Therefore, new processes for implementing the embodiment are not provided. It is noted that the embodiment is applicable to an IPS liquid crystal display in which the common electrode exists on the upper side of the pixel electrode. In this case, ITO can be formed simultaneously on the recess when the common electrode is patterned.

### Fifth Embodiment

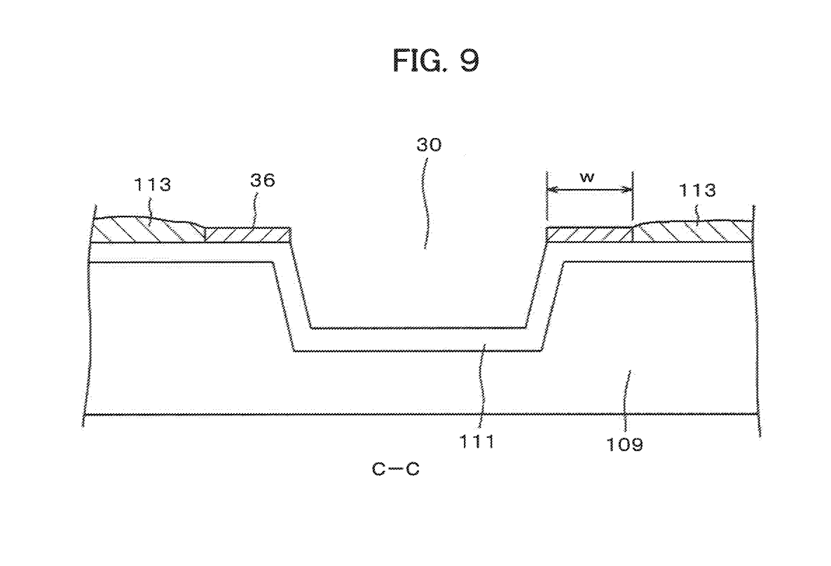

This embodiment provides another configuration in which the alignment film 113 is not formed on the recess 30 on the TFT substrate 100. FIG. 9 is a cross sectional view of a recess 30 according to the embodiment. In FIG. 9, the recess 30 is formed on the organic passivation film 109 by half-exposure. The interlayer insulating film 111 formed of SiN and the like is formed to cover the organic passivation film 109. The ITO film 36 is formed in a certain width on a flat peripheral portion around the recess 30.

The ITO film 36 has a poor wettability with the alignment film 113 as compared with SiN and the like forming the interlayer insulating film 111. On the other hand, a liquid alignment film material flows from a peripheral portion around the recess 30 into the recess 30. Therefore, the alignment film material flowing around the recess 30 is repelled by the ITO film of a poor wettability, and is not entered to the recess 30. Thus, the alignment film 113 does not exist in the inside of the recess 30, and a shave on the alignment film 113 is not taken place even though the second columnar spacer 20 contacts the recess 30.

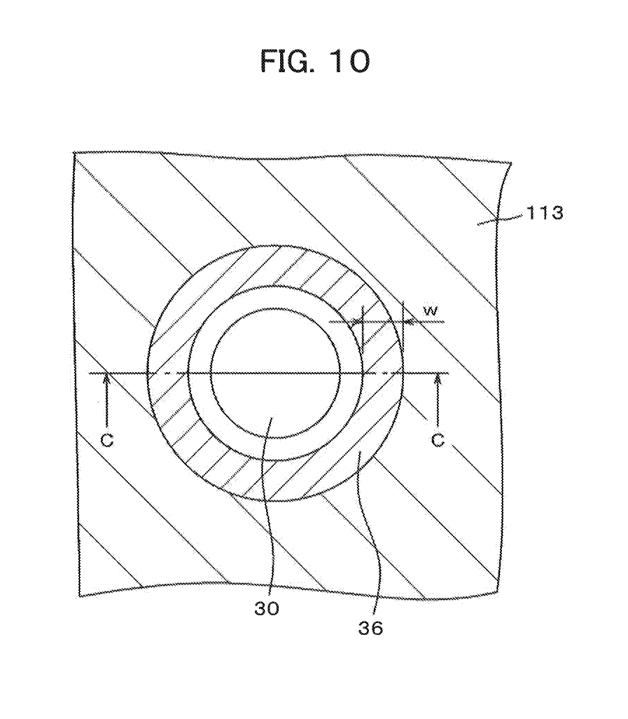

FIG. 10 is a plan view of the recess 30 according to the embodiment. FIG. 9 corresponds to a cross section along line C-C in FIG. 10. In FIG. 10, the bottom part and side wall of the recess 30 are seen in a circular shape, and the ITO film 36 is formed on the outer side of the recess 30 in a width w. Although the alignment film 113 is formed on the outer side of the ITO film 36, the alignment film is not formed on the inner side of the ITO film 36, that is, not formed on the recess 30.

Since the alignment film 113 is not formed on the inner side of the recess 30, the shavings of the alignment film are not produced even though an external pressure is applied to the counter substrate 200 to cause the second columnar spacer 20 to contact the recess 30. Therefore, the occurrence of a bright spot caused by the shavings of the alignment film 113 can be prevented.

The ITO film 36 according to the embodiment can also be formed simultaneously when the pixel electrode formed of ITO is formed. Therefore, new processes for implementing the embodiment are not provided. It is noted that the embodiment is applicable to an IPS liquid crystal display in which the common electrode exists on the upper side of the pixel electrode. Also in this case, ITO can be formed simultaneously on the recess 30 when the common electrode is patterned.

The description above is made on the configuration on the premise that the mode is the IPS mode, the columnar spacer is formed on the counter substrate, and the recess 30 is formed on the TFT substrate 100. However, at least the first to the third embodiments according to the present disclosure are also applicable to a configuration in which in the IPS mode, the columnar spacer is formed on the TFT substrate 100 side and the recess 30 is formed on the counter substrate 200. In this case, the recess 30 formed the counter substrate 200 is formed on the overcoat film 203.

Moreover, the present disclosure is also applicable to a liquid crystal display device in a mode other than the liquid crystal display device in the IPS mode including an organic passivation film on the TFT substrate.

According to the present disclosure, the columnar spacer formed corresponding to the recess on the other substrate does not contact the other substrate in the normal state, and contacts the bottom part of the recess only in the case where a pressing pressure is applied to the counter substrate, so that it is possible to decrease the probability that the alignment film is shaved on the recess. Therefore, it is possible to decrease the occurrence of light leakage or a bright spot caused by the shavings of the alignment film.

Moreover, according to the present disclosure, such a configuration is provided in which the alignment film is not easily entered to the recess, so that it is possible to decrease a shave on the alignment film even though the columnar spacer contacts the bottom part of the recess.

What is claimed is:

1. A liquid crystal display device comprising:
a first substrate having a recess and an upper part other than the recess;
a second substrate having a first columnar spacer and a second columnar spacer; and
a liquid crystal sandwiched between the first substrate and the second substrate,
wherein: the first columnar spacer contacts the upper part of the first substrate;
the second columnar spacer is inserted into the recess of the first substrate, and a gap exists between a tip end portion of the second columnar spacer and a bottom part of the recess; and
a height of the second columnar spacer is higher than a height of the first columnar spacer.

2. The liquid crystal display device according to claim 1,
wherein the recess is formed of a half hole formed on an organic film formed on the first substrate.

3. The liquid crystal display device according to claim 1,
wherein the recess is formed of a through hole formed on an organic film formed on the first substrate.

4. The liquid crystal display device according to claim 1,
wherein: the recess is formed of a first recess in a center part and a second recess surrounding the first recess;
the first recess is formed of a portion that an organic film formed on the first substrate is decreased in thickness by half-etching, and the second recess is formed of a region that the organic film formed on the first substrate is removed;
a gap exists between a tip end of the second columnar spacer and bottom parts of the first recess and the second recess; and
a distance between the tip end of the second columnar spacer and the bottom part of the first recess is smaller than a distance between the tip end of the second columnar spacer and the bottom part of the second recess.

5. The liquid crystal display device according to claim 1,
wherein ITO is formed on an inner surface of the recess.

6. The liquid crystal display device according to claim 1,
wherein ITO having a first width is formed on the upper part surrounding an outer end portion of the recess.

7. The liquid crystal display device according to claim 1,
wherein a number of the second columnar spacers is greater than a number of the first columnar spacers.

8. A liquid crystal display device comprising:
a TFT substrate including:
a scanning line extended in a first direction and arrayed in a second direction;
a picture signal line extended in the second direction and arrayed in the first direction;
an organic passivation film formed to cover the picture signal line;
a first electrode formed on the organic passivation film;
an interlayer insulating film formed to cover the first electrode;
a second electrode formed on the interlayer insulating film; and
a first alignment film formed on the second electrode;
a counter substrate including a first columnar spacer, a second columnar spacer, and a second alignment film formed on the counter substrate; and
a liquid crystal sandwiched between the TFT substrate and the counter substrate,
wherein: the TFT substrate having a recess and an upper part other than the recess;
the first columnar spacer contacts the upper part of the TFT substrate;
the second columnar spacer is inserted into the recess on the TFT substrate, and a gap exists between a tip end portion of the second columnar spacer and a bottom part of the recess; and
a height of the second columnar spacer is higher than a height of the first columnar spacer.

9. The liquid crystal display device according to claim 8, wherein the recess is formed of a half hole formed on the organic passivation film.

10. The liquid crystal display device according to claim 8, wherein the recess is formed of a through hole formed on the organic passivation film.

11. The liquid crystal display device according to claim 8,
wherein the recess is formed of a first recess in a center part and a second recess surrounding the first recess;
the first recess is formed of a portion that the organic passivation film is decreased in thickness by half-etching, and the second recess is formed of a region that the organic passivation film is removed;
a gap exists between a tip end of the second columnar spacer and bottom parts of the first recess and the second recess; and
a distance between the tip end of the second columnar spacer and the bottom part of the first recess is smaller than a distance between the tip end of the second columnar spacer and the bottom part of the second recess.

12. The liquid crystal display device according to claim 8, wherein ITO is formed on an inner surface of the recess.

13. The liquid crystal display device according to claim 8, wherein ITO having a first width is formed on the upper part surrounding an outer end portion of the recess.

14. The liquid crystal display device according to claim 8, wherein a number of the second columnar spacers is greater than a number of the first columnar spacers.
